(19) United States
(12) Patent Application Publication
(10) Pub. No.: US 2009/0084400 A1
(43) Pub. Date: Apr. 2, 2009

(54) Sheet-like and shaped articles for cleaning surfaces

(75) Inventor: Hans-Jürgen Quadbeck-Seeger, Bad-Durkheim (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/921,611

(22) PCT Filed: Jun. 9, 2006
(86) PCT No.: PCT/EP2006/063041

§ 371 Date: Dec. 6, 2007

(30) Foreign Application Priority Data
Jun. 10, 2005 (DE) 102005027040.9

(51) Int. Cl. B08B 1/00; A46D 1/00

(52) U.S. Cl. 134/6; 15/207.2

(57) ABSTRACT

Sheet-like and shaped articles for cleaning surfaces comprising melamine fibers, methods for cleaning surfaces using such sheet-like and shaped articles, the use of such sheet-like and shaped articles for cleaning surfaces, methods for producing such sheet-like and shaped articles using such fibers and the use of such fibers for producing such sheet-like and shaped articles.

The present invention relates to sheet-like and shaped articles for cleaning surfaces comprising melamine fibers, to methods for cleaning surfaces using such sheet-like and shaped articles, to the use of such sheet-like and shaped articles for cleaning surfaces, to methods for producing such sheet-like and shaped articles using such fibers and to the use of such fibers for producing such sheet-like and shaped articles.

Sheet-like and shaped articles for cleaning surfaces without the use of liquid auxiliaries, such as aqueous detergent solutions or alcohol, are known per se.

Thus, for example, cleaning cloths made of various natural or synthetic materials are used in the cleaning of spectacles.

Advantages of cleaning without the use of liquid auxiliaries is the simple and safe application, and also simple transportation of the sheet-like article.

A disadvantage of using such sheet-like and shaped articles is that their capacity is exhausted after a short use period and afterwards the soiling is no longer absorbed by the sheet-like article, but is only spread on the surface to be cleaned if cleaning is attempted.

The object of the present invention was to provide a sheet-like and shaped article which allows the cleaning of surfaces in a technically simple and economic manner while avoiding said disadvantages.

Accordingly, we have found the sheet-like article defined at the start and the shaped article defined at the start, a method for cleaning surfaces using such sheet-like and shaped articles, the use of such sheet-like and shaped articles for cleaning surfaces, methods for producing such sheet-like and shaped articles using the fibers defined at the start and the use of such fibers for producing such sheet-like and shaped articles.

According to the invention, the sheet-like and shaped articles for cleaning surfaces comprise melamine fibers.

The melamine fibers used according to the invention can be produced, for example, in accordance with the methods described in EP-A 93 965, DE-A 23 64 091, EP-A 221 330, EP-A 408 947, DE-A 10029334 or DE-A 10133787. Particularly preferred melamine fibers comprise, as monomer building block (A), 90 to 100 mol % of a mixture consisting essentially of 30 to 100 mol %, preferably 50 to 99 mol %, particularly 85 to 95 mol %, in particular 88 to 93 mol %, melamine and 0 to 70 mol %, preferably 1 to 50 mol %, particularly preferably 5 to 15 mol %, in particular 7 to 12 mol %, of a substituted melamine I or mixtures of substituted melamines I.

As further monomer building block (B), the particularly preferred melamine fibers comprise 0 to 10 mol %, preferably from 0.1 to 9.5 mol %, in particular 1 to 5 mol %, based on the total molar number of monomer building blocks (A) and (B), of a phenol or of a mixture of phenols.

The particularly preferred melamine fibers are usually obtainable by reacting the components (A) and (B) with formaldehyde or formaldehyde-supplying compounds and subsequent spinning, where the molar ratio of melamine to formaldehyde is in the range from 1:1.15 to 1:4.5, preferably from 1:1.8 to 1:3.0.

Suitable substituted melamines of the general formula I

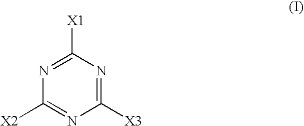

are those in which X¹, X² and X³ are selected from the group consisting of —NH₂, —NHR¹ and —NR¹R², where X¹, X² and X³ are not —NH₂ at the same time, and R¹ and R² are selected from the group consisting of hydroxy-C₂-C₁₀-alkyl, hydroxy-C₂-C₄-alkyl-(oxa-C₂-C₄-alkyl)ₙ, where n=1 to 5, and amino-C₂-C₁₂-alkyl.

As hydroxy-C₂-C₁₀-alkyl groups, preference is given to selecting hydroxy-C₂-C₆-alkyl, such as 2-hydroxyethyl, 3-hydroxy-n-propyl, 2-hydroxyisopropyl, 4-hydroxy-n-butyl, 5-hydroxy-n-pentyl, 6-hydroxy-n-hexyl, 3-hydroxy-2,2-dimethylpropyl, preferably hydroxy-C₂-C₄-alkyl, such as 2-hydroxyethyl, 3-hydroxy-n-propyl, 2-hydroxyisopropyl and 4-hydroxy-n-butyl, particularly preferably 2-hydroxyethyl and 2-hydroxyisopropyl.

As hydroxy-C₂-C₄-alkyl-(oxa-C₂-C₄-alkyl)ₙ groups, preference is given to selecting those where n=1 to 4, particularly preferably those where n=1 or 2, such as 5-hydroxy-3-oxa-pentyl, 5-hydroxy-3-oxa-2,5-dimethylpentyl, 5-hydroxy-3-oxa-1,4-dimethylpentyl, 5-hydroxy-3-oxa-1,2,4,5-tetramethylpentyl, 8-hydroxy-3,6-dioxaoctyl.

Suitable amino-C₂-C₁₂-alkyl groups are preferably amino-C₂-C₈-alkyl groups, such as 2-aminoethyl, 3-aminopropyl, 4-aminobutyl, 5-aminopentyl, 6-aminohexyl, 7-aminoheptyl, and 8-aminooctyl, particularly preferably 2-aminoethyl and 6-aminohexyl, very particularly preferably 6-aminohexyl.

Substituted melamines particularly suitable for the invention are the following compounds:

melamines substituted with the 2-hydroxyethylamino group, such as 2-(2-hydroxyethyl-amino)-4,6-diamino-1,3,5-triazine, 2,4-di(2-hydroxyethylamino)-6-amino-1,3,5-triazine, 2,4,6-tris-(2-hydroxyethylamino)-1,3,5-triazine, melamines substituted with the 2-hydroxyisopropylamino group, such as 2-(2-hydroxyisopropylamino)-4,6-diamino-1,3,5-triazine, 2,4-di(2-hydroxyisopropylamino)-6-amino-1,3,5-triazine, 2,4,6-tris(2-hydroxy-isopropylamino)-1,3,5-triazine, melamines substituted with the 5-hydroxy-3-oxapentylamino group, such as 2-(5-hydroxy-3-oxapentylamino)-4,6-diamino-1,3,5-triazine, 2,4,6-tris-(5-hydroxy-3-oxapentylamino)-1,3,5-triazine, 2,4-di(5-hydroxy-3-oxapentylamino)-6-amino-1,3,5-triazine, melamines substituted with the 6-aminohexylamino group, such as 2-(6-aminohexylamino)-4,6-diamino-1,3,5-triazine, 2,4-di(6-aminohexylamino)-6-amino-1,3,5-triazine, 2,4,6-tris-(6-aminohexylamino)-1,3,5-triazine or mixtures of these compounds, for example a mixture of 10 mol % of 2-(5-hydroxy-3-oxapentylamino)-4,6-diamino-1,3,5-triazine, 50 mol % of 2,4-di(5-hydroxy-3-oxapentylamino)-6-amino-1,3,5-triazine and 40 mol % of 2,4,6-tris-(5-hydroxy-3-oxapentylamino)-1,3,5-triazine.

Suitable phenols (B) are phenols comprising one or two hydroxy groups which are optionally substituted with radicals selected from the group of C₁-C₉-alkyl and hydroxy, and C₁-C₄-alkanes substituted with two or three phenol groups, di(hydroxyphenyl)-sulfones or mixtures of these phenols.

Suitable preferred phenols are: phenol, 4-methylphenol, 4-tert-butylphenol, 4-n-octylphenol, 4-n-nonylphenol, pyrocatechin, resorcinol, hydroquinone, 2,2-bis(4-hydroxyphenyl)propane, bis(4-hydroxyphenyl)sulfone, particularly preferably phenol, resorcinol and 2,2-bis(4-hydroxyphenyl)propane.

Formaldehyde is usually used in the form of an aqueous solution with a concentration of, for example, 40 to 50% by weight or in the form of compounds which produce formaldehyde in the reaction with (A) and (B), for example as oligomeric or polymeric formaldehyde in solid form, such as paraformaldehyde, 1,3,5-trioxane or 1,3,5,7-tetroxane.

The production of the particularly preferred melamine fibers usually involves the polycondensation of melamine, optionally substituted melamine and, if appropriate, phenol together with formaldehyde or formaldehyde-supplying compounds. All of the components can be introduced right at the start, or they can be reacted in portions and successively, and further melamine, substituted melamine or phenol can be added subsequently to the thereby formed precondensates.

The polycondensation is carried out in a manner known per se (see EP-A 355 760, Houben-Weyl, Vol. 14/2, p. 357 ff).

The reaction temperature chosen here is generally in a range from 20 to 150° C., preferably from 40 to 140° C. The reaction pressure is usually uncritical. The procedure is generally carried out in a range from 100 to 500 kPa, preferably under atmospheric pressure.

The reaction can be carried out with or without solvents. As a rule, when using aqueous formaldehyde solution, no solvent is added. When using formaldehyde bound in solid form, the solvent chosen is usually water, the amount used generally being in the range from 5 to 40% by weight, preferably from 15 to 200% by weight, based on the total amount of monomers used.

In addition, the polycondensation is generally carried out in a pH range above 7. Preference is given to the pH range from 7.5 to 10.0, particularly preferably from 8 to 9.

Furthermore, small amounts of customary additives can be added to the reaction mixture, such as alkali metal sulfites, for example sodium disulfite and sodium sulfite, alkali metal formates, for example sodium formate, alkali metal citrates, for example sodium citrate, phosphates, polyphosphates, urea, dicyandiamide or cyanamide. They can be added as pure individual compounds or as mixtures with one another, in each case without a diluent or as aqueous solution, before, during or after the condensation reaction.

Other modifying agents are amines and amino alcohols, such as diethylamine, ethanolamine, diethanolamine or 2-diethylaminoethanol.

Suitable further additives are fillers or emulsifiers. Fillers which can be used are, for example, fibrous or pulverulent inorganic reinforcing agents or fillers, such as glass fibers, metal powders, metal salts or silicates, for example kaolin, talc, barite, quartz or chalk, also pigments and dyes. Emulsifiers which can be used are usually the customary nonionogenic, anion-active or cation-active organic compounds with long-chain alkyl radicals.

The polycondensation can be carried out discontinuously or continuously, for example in an extruder (see EP-A 355 760) in accordance with methods known per se.

To produce fibers, the melamine resin according to the invention is usually spun in a manner known per se, for example after adding a hardener, for example acids, such as formic acid, sulfuric acid or ammonium chloride, at room temperature in a rotary spinning machine and then the crude fibers are hardened in a heated atmosphere, or spinning is carried out in a heated atmosphere, evaporating at the same time the water serving as solvent and hardening the condensate. Such a method is described in detail in DE-A-23 64 091.

However, to produce the melamine fibers it is also possible to use other customary methods, e.g. thread-drawing, extrusion and fibrillation processes. The fibers obtained in these processes are generally predried, if appropriate stretched and then hardened at 120 to 250° C.

The fibers are usually 5 to 25 μm thick and 2 to 2000 mm long. Suitable melamine resins are commercially available, for example, as Basofil® from BASF Aktiengesellschaft.

The sheet-like and shaped articles according to the invention for cleaning surfaces can consist of melamine fibers or, besides melamine fibers, comprise one or more types of other fibers. Of suitability here are natural fibers, synthetic fibers or mixtures thereof.

The natural fibers used are normally naturally occurring fibers based on cellulose, such as cotton, wool, linen or silk, these natural fibers also including those cellulose-based fibers which are of natural origin but have been modified or treated by known and customary methods.

In particular, according to DIN 60001, cotton or wool belong to the natural fibers, where cotton is to be assigned to the group of vegetable fibers. DIN 60004 lays down the definitions of the raw material wool. For the purposes of this invention, wool is to be understood as meaning all coarse and fine animal hair.

The natural fibers can, if required, be treated with flame-retardant compositions, for example reactive phosphorus compounds. Such compounds are commercially available, for example, as Afflammit®, Pyrovatex® or Proban®.

Suitable synthetic fibers are preferably polyester fibers, polyamide fibers or viscose fibers different therefrom, or mixtures thereof.

As polyester fibers or polyamide fibers, it is possible to use all customary textile fibers consisting of polyester or polyamide. Such fibers are known. Polyester fibers are produced from linear saturated polyesters, such as, for example, polyethylene terephthalate (PET) and/or polybutylene terephthalate (PBT), which are composed of dihydric alcohols, in particular glycols, and aromatic dicarboxylic acids, mostly terephthalic acid.

The polyamide fibers and polyester fibers are usually produced by the melt spinning method or the extrusion method, after which they are stretched while hot. Through subsequent heat treatment, they can be made highly crystalline and low-shrink. Details on polyester fibers are available to the person skilled in the art in Ullmann's Encyclopedia of Industrial Chemistry, Vol. 11, 4th edition, p. 305, Verlag Chemie, Weinheim 1978.

In a preferred embodiment, the synthetic fibers, for example of polyethylene, polypropylene, polyester, polyamide, polymethyl methacrylate, polystyrene, can be used as microfibers. Microfibers are understood as meaning threads with individual titers of at most 1.1 dtex per fiber (0.11 g/1000 m of fiber), preferably between 0.3 (0.03 g/1000 m of fiber) and 1.1 dtex per fiber (0.11 g/1000 m of fiber), before stretching.

Details on microfibers and methods of producing them can be found, for example, in Fourné, Synthetic Fibers, Carl Hanser Verlag, Munich-Vienna, 1995, pp. 551-563.

Polyamide fibers are produced from various polyamide (PA) grades, primarily from PA-66 and PA-6, and also from PA-11 and PA-610, by the melt spinning method or the extrusion method. They are then stretched while hot or cold. PA-6 is polycaprolactam, PA-66 is composed of hexamethylenediamine and adipic acid units. PA-11 is composed of 11-aminoundecanoic acid, PA-610 of hexamethylenediamine and sebacic acid. Details on polyamide fibers can be found by the person skilled in the art in Ullmann's Encyclopedia of Industrial Chemistry, Vol. 11, 4th edition, p. 315, Verlag Chemie, Weinheim 1978.

Suitable polyester fibers are commercially available, for example, as Trevira® fibers from Trevira GmbH and Teretal® fibers from Montefibre. Suitable polyamide fibers are commercially available, for example, from BASF, DuPont and Rhodia.

Viscose fibers are preferably spun from cellulose by the viscose method: wood pulp (cellulose) is treated with sodium hydroxide solution. The resulting alkali cellulose is squeezed, comminuted and left to stand in air. The alkali cellulose preripened in this way is treated with carbon disulfide CS₂, giving cellulose xanthogenate. The xanthogenate is dissolved in dilute sodium hydroxide solution to give a viscous spinning solution (so-called viscose). The spinning solution is filtered and stored. The spinning solution after-ripened in this way is pumped through spinning nozzles into a spinning bath comprising sulfuric acid, sodium sulfate and zinc sulfate, where the viscose coagulates to give fine cellulose threads. The threads are, if appropriate, stretched, then washed and aftertreated. Further details on viscose fibers can be found by the person skilled in the art in the mentioned book by S. Rogowin, pp. 76-197.

If, besides melamine resin fibers, the sheet-like and shaped articles according to the invention comprise other fibers, such as natural fibers, synthetic fibers or mixtures thereof, then preference is given to those sheet-like articles which comprise at least 5% by weight, preferably at least 10% by weight, particularly preferably at least 20% by weight of melamine resin fibers, based on the sum of melamine resin fibers, natural fibers, synthetic fibers or mixtures thereof in the sheet-like article.

If, besides melamine resin fibers, the sheet-like and shaped articles according to the invention comprise other fibers, such as natural fibers, synthetic fibers or mixtures thereof, then preference is given to those sheet-like articles which comprise at most 99% by weight, preferably at least 95% by weight, particularly preferably at least 90% by weight, in particular at most 80% by weight of melamine resin fibers, based on the sum of melamine resin fibers, natural fibers, synthetic fibers or mixtures thereof in the sheet-like article.

Up to 25% by weight, preferably up to 10% by weight, of customary fillers, in particular those based on silicates, such as mica, and also dyes, pigments, metal powders, matting agents and spinning auxiliaries, can be added to the sheet-like and shaped articles according to the invention.

In particular, the sheet-like articles according to the invention can comprise additives with an antistatic action, corresponding to DIN EN 114-1.

The threads used for producing the sheet-like and shaped articles according to the invention and/or the fibers present therein can be treated in a known manner before they are processed to give the fabric, e.g. by prebleaching, dyeing, finishing with textile auxiliaries, hydrophobicization, etc.

The various types of fibers are usually premixed in the form of a flock and spun into yarns by means of known methods customary in the textile industry. However, it is also possible to process the fibers in another way to give yarns. Such methods are known to the person skilled in the art.

Depending on the field of use, these yarns can then be further processed to give different types of textile or nontextile wovens.

Preferably, the yarns have a fineness of from Nm 5 to Nm 70, in particular Nm 20 to Nm 50. The weight per unit area of the fabric according to the invention produced therefrom is preferably 70 to 900, in particular 120 to 600 and particularly preferably 300 to 500 g/cm².

The various types of fibers can likewise be premixed as a flock in a manner customary per se and be processed to nonwovens by means of known methods customary in the textile industry, giving the sheet-like or shaped articles according to the invention.

Suitable shaped articles according to the invention are preferably those which have melamine fibers on the outside such that, when cleaning a surface, said surface comes into contact with the melamine fibers of the shaped article.

Shaped articles according to the invention can advantageously be obtained by coating a shaped article, preferably a porous shaped article, such as an inelastic, advantageously an elastic, open or closed-pore natural, preferably synthetic, sponge, with melamine fibers or yarns of melamine fibers.

Such shaped articles, in particular sponges, and methods for their coating with fibrous material are known per se.

The sheet-like and shaped articles according to the invention can comprise a heat-, oil- soiling- and/or moisture-repellent and/or oil-, soiling- and/or moisture-adsorbing finishing. The sheet-like and shaped articles can be impregnated or coated with the finishing composition.

Such compounds are known as textile auxiliaries to the person skilled in the art (cf. Ullmann's Encyclopedia of Industrial Chemistry 5th Ed., Vol. A26, pp. 306-312). Examples of water-repellent compounds are metal soaps, silicones, organofluorine compounds, for example salts of perfluorinated carboxylic acids, polyacrylic acid esters of perfluorinated alcohols (see EP-B-366 338 and literature cited therein) or tetrafluoroethylene polymers. In particular, the two last-mentioned polymers are also used as oleophobic finishing.

The sheet-like and shaped articles according to the invention combine good abrasion resistance, good washing and drying behavior under industrial conditions (low wash-out of fibers), and high mechanical strength with good cleaning effect of surfaces.

For cleaning surfaces using the sheet-like and shaped articles according to the invention, the surfaces can simply be wiped.

This wiping can take place using liquid auxiliaries, such as aqueous detergent solutions or organic liquid solvents, such as alcohols, in particular methanol, ethanol, isopropanol, n-propanol, such as ketones, in particular acetone or methyl ethyl ketone, such as aliphatic or aromatic, halogenated or nonhalogenated hydrocarbons.

This wiping can advantageously take place without the use of such liquid auxiliaries.

The wiping can take place by manual rubbing of the surface with a sheet-like or shaped article according to the invention.

The wiping can likewise by machine rubbing of the surface with a sheet-like or shaped article according to the invention, for example using polishing machines known per se, as are known, for example, for the polishing of automotive paint surfaces or parquet floors.

Accordingly, various geometric configurations are suitable for the sheet-like and shaped articles according to the invention.

For manual cleaning, cleaning cloths can advantageously be used, i.e. two-dimensional flat structures which partially or completely have the sheet-like article according to the invention, or cleaning gloves, i.e. gloves whose outer surface has completely or partially, in particular completely or partially on the side of the glove facing the palm of the hand, a sheet-like article according to the invention, or brushes, preferably those which have melamine resin fibers on their own or in a mixture with said natural fibers, synthetic fibers or mixtures thereof or sheet-like or shaped articles according to the invention partially or completely as bristles or cleaning strips.

In the case of machine cleaning, the shape of the sheet-like or shaped article should preferably depend on the sheet-like or shaped article by means of the machine the movement of the surface to be cleaned and with respect to the sheet-like article according to the invention the attachment of the machine. Of primary suitability are thus round, ellipsoidal, belt-like or roll-like sheet-like or shaped articles.

The sheet-like and shaped articles according to the invention are suitable per se for cleaning highly diverse surfaces.

Particularly good cleaning effects can be achieved on smooth surfaces, such as on glass, on coated or uncoated metal, on glazed materials, such as ceramics, porcelain or stoneware, on painted or unpainted plastic surfaces.

In this connection, the surfaces to be cleaned should have greater hardness than the sheet-like or shaped articles that are abrasion-resistant due to the melamine fibers, used according to the invention for cleaning the surface, in order to avoid scratching of the surface to be cleaned. A preliminary test in this regard can be readily carried out in a technically simple manner.

Suitable glass surfaces are, for example, glass panes, such as window panes, display screen surfaces or the bearing surfaces in photocopiers or scanners, or optical lenses, for example in spectacles, binoculars or microscopes.

Suitable plastic surfaces are, for example, furniture surfaces, the surfaces of electrical or electronic appliances, plastic surfaces in the interior fitments of motor vehicles or optical lenses, for example in spectacles, binoculars or microscopes.

The sheet-like and shaped articles according to the invention have proven particularly advantageous for the removal of greasy soiling, in particular skin sebum, such as fingermarks, from surfaces, preferably from glass surfaces or plastic surfaces, in particular from glass surfaces.

Should the cleaning effect of the sheet-like and shaped articles according to the invention deteriorate upon frequent use, then the sheet-like and shaped articles according to the invention can be cleaned in a manner customary per se, in particular using liquid auxiliaries, to regain their original cleaning effect.

### EXAMPLES

### Example 1

For the examples and comparative examples, a pane of mirror glass as surface was supplied with the following substances as soiling:

Soiling A: Hair spray (Taft hair spray extra hold, Schwarzkopf) was sprayed on.
Soiling B: Chicken egg white was spread onto the pane

Both soilings were dried in the air at ambient temperature for 24 hours.

Removal of the soilings with the following sheet-like articles (referred to below as “cloth”) was investigated:

Cloth 1 (comparison): cotton cloth (VILEDA household cloth, Freudenberg)
Cloth 2 (comparison): microfiber cloth (Spontex “Window Wonder Ultrafine Microfibers”, MAPA GmbH)
Cloth 3 (according to the invention): nonwoven of melamine fibers (BASOFIL®, BASF Aktiengesellschaft)

To test the cleaning effect of cloth 1, 2 and 3, surfaces with soiling A or soiling B were rubbed back and forth in each case five times with the respective cloth (i.e. soiling A or soiling B was crossed a total of ten times). The cleaning effect was assessed visually and evaluated as follows:

No effect (−)
Slight effect (−)
Noticeable effect (−)
Clear effect (+)
Good effect (++)
Very good effect (+++)

The following results were obtained:

| | Soiling A | Soiling B |
|---|---|---|
| Cloth 1 | (−−−) | (−−−) |
| Cloth 2 | (−−−) | (−−−) |
| Cloth 3 | (−−) | (−−) |

### Example 2

The procedure was as in example 1 except that the surface with the soiling was slightly breathed on before rubbing.

The following results were obtained:

| | Soiling A | Soiling B |
|---|---|---|
| Cloth 1 | (−−) | (−−−) |
| Cloth 2 | (−−) | (−−−) |
| Cloth 3 | (+) | (−) |

### Example 3

The procedure was as in example 1 except that cloth 1, 2 and 3 were wetted with water before carrying out example 3.

The following results were obtained:

| | Soiling A | Soiling B |
|---|---|---|
| Cloth 1 | (++) | (+) |
| Cloth 2 | (++) | (++) |
| Cloth 3 | (+++) | (+++) |

It was found that in all of the examples the cloth according to the invention had considerably better cleaning properties compared to the comparison cloths.

1. (canceled)

2. (canceled)

3. (canceled)

4. (canceled)

5. A method for cleaning surfaces wherein sheet-like and shaped articles comprising melamine fibers are used for the cleaning.

6. The method of claim 5 further comprising aqueous detergent solutions, alcohols or ketones.

7. The method of claim 5 further comprising contacting the surface with a belt-like or roll-like sheet-like or shaped article used in a polishing machine.

8. The method of claim 5 wherein the surfaces are glass or plastic.

9. The method of claim 5 further comprising contacting the surface with the bristles of a brush wherein the bristles comprise melamine fibers.

10. A brush for cleaning surfaces wherein the bristles comprise melamine fibers.
